(19) United States
(12) Patent Application Publication
(10) Pub. No.: US 2021/0190305 A1
(43) Pub. Date: Jun. 24, 2021

(54) Grow light with shields

(71) Applicant: HORTICULTURE LIGHTING GROUP CORP., Westerville, OH (US)

(72) Inventors: Stephen Johnson, Westerville, OH (US); Amit Chandna, Westerville, OH (US)

(21) Appl. No.: 17/132,964

(22) Filed: Dec. 23, 2020

Related U.S. Application Data
(60) Provisional application No. 62/952,825, filed on Dec. 23, 2019.

(51) Int. Cl. F21V 25/12; A01G 9/24

(52) U.S. Cl. CPC F21V 25/12; F21Y 2115/10; A01G 9/249

(57) ABSTRACT

Apparatus for providing fire protection and/or an electrical enclosure for a grow light having at least one light assembly that contains an array of light emitting diodes (LEDs). A fire protection shield is a planar sheet configured to fit over a light assembly with the circuit shield including openings sized to allow the LEDs to protrude therethrough such that the circuit shield allows transmission of light emitted from the LEDs. The electrical enclosure is a wire shield, or wire cover, configured to cover the exposed conductors electrically connected to the light assemblies. The wire cover extends beyond the light assembly, offering both physical and electrical protection of the light assembly. The light assembly is attached to one side of a base plate that has a power supply on an opposite side. In one embodiment, the base plate includes a plurality of lamp portions, each having a light assembly.

### CROSS-REFERENCE TO RELATED APPLICATIONS

This application claims the benefit of U.S. Provisional Application No. 62/952,825, filed Dec. 23, 2019.

### STATEMENT REGARDING FEDERALLY SPONSORED RESEARCH OR DEVELOPMENT

Not Applicable

### BACKGROUND

### 1. Field of Invention

This invention pertains to a grow light with shields. More particularly, this invention pertains to fire protection shields and electrical protection shields for a lamp assembly with light emitting diodes protruding therefrom.

### 2. Description of the Related Art

Grow lights provide artificial light to help plants grow. Grow lights are typically used to mimic outdoor conditions by providing the intensity and light spectrum necessary for specific plants to grow. Grow lights allow for growing plants in specialized structures without having to tolerate the vagaries of the weather and the inefficiency of having only one level to grow plants.

In order to mimic sunlight, grow lights provide high intensity. Various types of grow lights use incandescent bulbs, florescent lights, high-intensity discharge lamps (HID), metal halide lights, and light emitting diodes (LED). Grow lights, because of their high intensity illumination, generate large amounts of heat and often use lots of power. The heat must be handled in a safe manner to avoid the grow light being a fire hazard. The power must be contained against electrical faults.

Grow lights are subject to fire protection standards. Also, because grow lights are electrically powered, they are subject to electrical standards. These standards vary based on the use of the grow light, that is, consumer or commercial/industrial use. Grow lights are used in industrial settings and are also used in consumer or home type environments. Generally, consumer level grow lights have the most strict standards for fire and electrical safety due to their potential use in close proximity to residential spaces.

### BRIEF SUMMARY

According to one embodiment of the present invention, circuit shields and conductor shields are provided. The circuit shields are proximate the light emitting diodes of a grow light and the conductor shields are proximate point-to-point wiring between LED panels. The shields offer fire protection and electrical protection for the circuits associated with the grow light. The grow light has an array of light emitting diodes (LED) positioned to direct light away from the bottom of the grow light. The mounting board for the LEDs includes a circuit, or fire protection, shield that is a flame barrier. The flame barrier, or circuit shield, is flame retardant material that covers the mounting board with openings for the LEDs to protrude so that the circuit shield does not block the light. The circuit shield also provides another layer of electrical protection for the circuit traces between the LEDs. In one embodiment, the circuit shield also has an outer surface that aids in reflecting the light from the LEDs, thereby ensuring that as much light as possible is directed downward, away from the mounting board.

The conductor, or electrical protection, shields are wire covers that enclose and protect the exposed point-to-point wiring on the surface of the lamp portion of the grow light. Point-to-point wiring is wiring, typically insulated conductors, but sometimes bare conductors, that provide electrical connections between components or connections on printed circuit boards. The wire covers are electrically insulating so as to prevent unintentional contact with the point-to-point wiring connecting individual LED circuit boards.

The conductor shields also provide fire protection by being a fire barrier between the electrical conductors contained by the conductor shields and the environment outside the conductor shields. The wire covers extend beyond the outer face of the LEDs and the circuit shield, away from the lamp portion of the grow light. In this way, the wire covers provide support and provide mechanical shielding of the LEDs when the grow light is resting on a surface, such as may occur during installation and maintenance.

The combination of the circuit shields and the wire covers provide an enclosure for the electrical traces and wiring of the lamp portion of the grow light. That enclosure protects against electrical hazards and fire hazards.

In one embodiment the grow light includes a light assembly including a plurality of light emitting diodes on one surface of said light assembly, said light assembly including a first conductor connected to said plurality of light emitting diodes, said light assembly including a second conductor electrically connected to said first conductor, said second conductor providing a power connection to said plurality of light emitting diodes; a circuit shield configured to attach to said one surface of said light assembly, said circuit shield dimensioned to cover said first conductor, and said circuit shield being a fire barrier; and a wire shield configured to attach to said one surface of said light assembly, said wire shield enclosing said second conductor, and said wire shield is an electrical and fire barrier.

In one embodiment the grow light includes: a light assembly including a plurality of light emitting diodes on one surface of said light assembly, said light assembly including a first conductor connected to said plurality of light emitting diodes, said light assembly including a second conductor electrically connected to said first conductor, said second conductor providing a power connection to said plurality of light emitting diodes; and a circuit shield configured to attach to said one surface of said light assembly, said circuit shield dimensioned to cover said first conductor, and said circuit shield being a fire barrier.

In one such embodiment, the circuit shield is a planar sheet, and said circuit shield includes a plurality of openings spaced to correspond to said plurality of light emitting diodes whereas said light emitting diodes project light through said plurality of openings when said plurality of light emitting diodes are energized. In various such embodiments, the circuit shield is an electrical insulator and the circuit shield is attached to said light assembly with an adhesive or with a plurality of fasteners.

In one embodiment the grow light includes a light assembly including a plurality of light emitting diodes on one surface of said light assembly, said light assembly including a first conductor connected to said plurality of light emitting diodes, said light assembly including a second conductor electrically connected to said first conductor, said second conductor providing a power connection to said plurality of light emitting diodes; and a wire shield configured to attach to said one surface of said light assembly, said wire shield enclosing said second conductor.

In one embodiment, the wire shield includes a bottom and four sides forming a box-shape with an open side, said bottom and said four sides defining a cavity dimensioned to receive a portion of said second conductor, and said open side configured to engage said circuit shield and said light assembly when positioned to cover said second conductor. In one such embodiment, the wire shield is an electrical insulator. In another such embodiment, the wire shield is a fire barrier.

### BRIEF DESCRIPTION OF THE SEVERAL VIEWS OF THE DRAWINGS

The above-mentioned features will become more clearly understood from the following detailed description read together with the drawings in which:

FIG. 1 is a bottom view of one embodiment of a grow light with shields in place.

FIG. 2 is an upside-down side view of the grow light of FIG. 1.

FIG. 3 is an exploded upside-down side view of one embodiment of the grow light.

FIG. 4 is a partial exploded view of the grow light.

FIG. 5 is a bottom view of the lamp portion of the base plate of the grow light.

FIG. 6 is a plan view of a circuit shield.

FIG. 7 is a perspective view showing the open side of one embodiment of a wire shield.

FIG. 8 is a plan view of the open side of the wire shield shown in FIG. 7.

FIG. 9 is a side view of the wire shield shown in FIG. 7.

FIG. 10 is an end view of the wire shield shown in FIG. 7.

FIG. 11 is a bottom view of a second embodiment of a grow light with shields in place.

FIG. 12 is a upside-down side view of the grow light of FIG. 11.

### DETAILED DESCRIPTIONS

Apparatus for fire protection shields 116 and electrical protection shields 106 for a light emitting diode (LED) grow light 100 are disclosed. The grow light is generally indicated as 100, with particular embodiments and variations shown in the figures and described below having an alphabetic suffix, for example, 100-A, 100-B. Various components are illustrated both generically and specifically in the figures and in the following description. For example, the conductors 302-A, 302-B are discussed individually and separately to ensure clarity when describing the configuration of each type of conductor 302-A, 302-B. The conductors 302, when referred to generically, are referenced without the alphanumeric suffix.

The positions, for example, bottom and top, are relative to the grow light 100 in its installed position, with the light 100 above the plants to be illuminated.

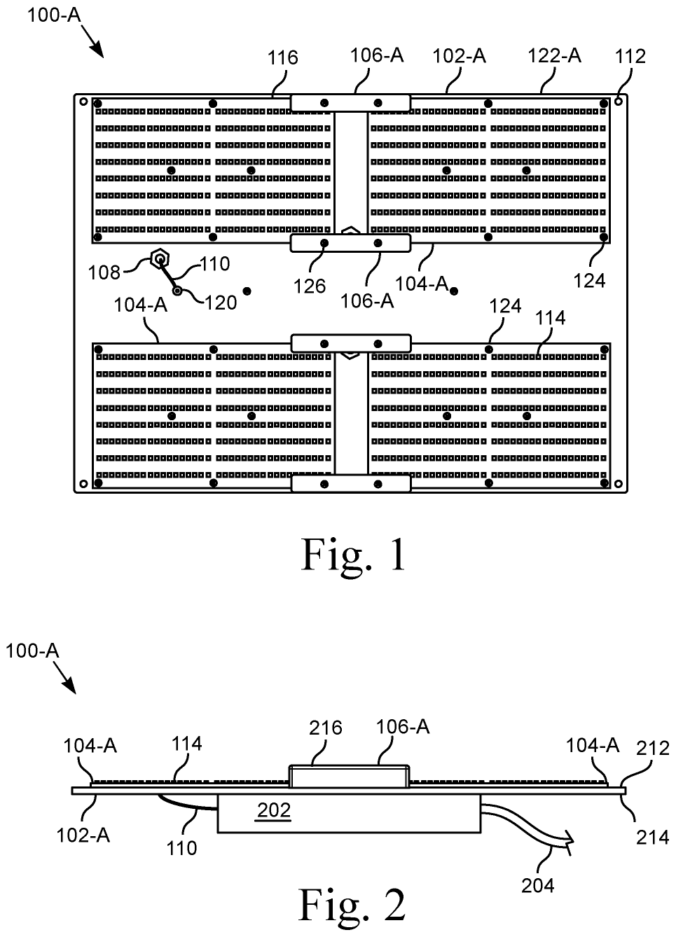

FIG. 1 illustrates a bottom view of one embodiment of a grow light 100-A with shields 106-A, 116 in place. FIG. 2 illustrates an upside-down side view of the grow light 100-A of FIG. 1. The illustrated embodiment of the grow light 100-A includes a lamp portion 122-A with four each circuit shields 116 and four each conductor shields, or wire covers, 106-A. The circuit shields 116 are primarily fire protection shields and are referred herein as circuit shields 116, fire shields 116, and fire protection shields 116 interchangeably. The conductor shields 106 are primarily electrical protection shields and are referred herein as wire covers 106, covers 106, wire shields 106, and conductor shields 106, interchangeably. Both types of shields 116, 106-A provide fire protection and electrical protection functions to varying degrees.

The base plate 102-A includes a lamp portion 122-A, multiple light assemblies 104-A on the bottom side 212, and a power supply 202 on the top side 214. In one embodiment, the base plate 102-A is an aluminum plate or panel that serves as a heat sink for dissipating heat generated by the lamp portion 122-A. In one such embodiment, the plate 102-A is surface treated to have high thermal emissivity, which aids in dissipating heat generated by the lamp portion 122-A. For example, the plate 102-A is powder coated or anodized. The base plate 102-A includes spaced holes 112 configured for supporting the grow light 100-A. In various embodiments, the holes 112 receive eye-bolts or hooks that are attached to chains, straps, or cables suspended from an overhead structure, such as a ceiling. In this way the grow light 100-A is supported above the plants to be illuminated with the bottom 212 of the grow light 100-A facing the plants to be illuminated.

The lamp portion 122-A is the part or portion of the base plate 102-A that includes the light assemblies 104-A. In the illustrated embodiment, the lamp portion 122-A supports four light assemblies 104-A arranged in an array of two pairs of adjacent light assemblies 104-A. The lamp portion 122-A also provides a heat sink for the heat generated by the light assemblies 104-A.

The bottom side or surface 212 of the base plate 102-A includes an array of four light assemblies 104-A, with each light assembly 104-A having an array of multiple rows of light emitting diodes (LEDs) 114. In one such embodiment, the LEDs 114 are surface mount devices with the light emitting portion directed away from the planar surface of the light assembly 104-A. In such an embodiment, the surface of the light assembly 104-A includes circuit traces 402 that provide electrical connections to the LEDs 114. In one such embodiment, the circuit traces 402 have an insulating coating over the traces.

Each of the light assemblies 104-A has a corresponding circuit, or fire protection, shield 116. Adjacent pairs of light assemblies 104-A have wire covers, or conductor shields, 106-A extending therebetween. The bottom surface 216 of the wire covers 106-A extends beyond the LEDs 114 protruding from the light assemblies 104-A and past the circuit shields 116. In this way, the wire covers 106-A support the grow light 100-A and protect the light assemblies 104-A when the grow light 100-A is positioned on a flat surface, such as during installation or maintenance.

The top side 214 of the base plate 102-A includes a power supply 202 that is attached to the plate 102-A. Extending from the power supply 202 is a power cable 204. The power cable 204 is configured to connect to a power source for providing power to the grow light 100-A. Also extending from the power supply 202 is a ground wire 110. In the illustrated embodiment, the ground wire 110 extends through a pass-through fitting 108 and is terminated at a ground screw 120 on the bottom side 212 of the plate 102-A. In another embodiment, the ground wire 110 is terminated at the top side 214 of the plate 102-A.

In the illustrated embodiment, the grow light 100-A includes multiple fasteners 124, 126. The circuit shields 116 and the light assemblies 104-A are attached and secured to the base plate 102-A with multiple fasteners 124 spaced apart with the fasteners 124 engaging openings 324. The wire covers 106-A are attached and secured to the light assemblies 104-A and the base plate 102-A with multiple fasteners 126. In various embodiments, the fasteners 124, 126 are rivets or threaded screws or bolts. In another embodiment, the circuit shields 116 are attached to the light assemblies 104-A with an adhesive.

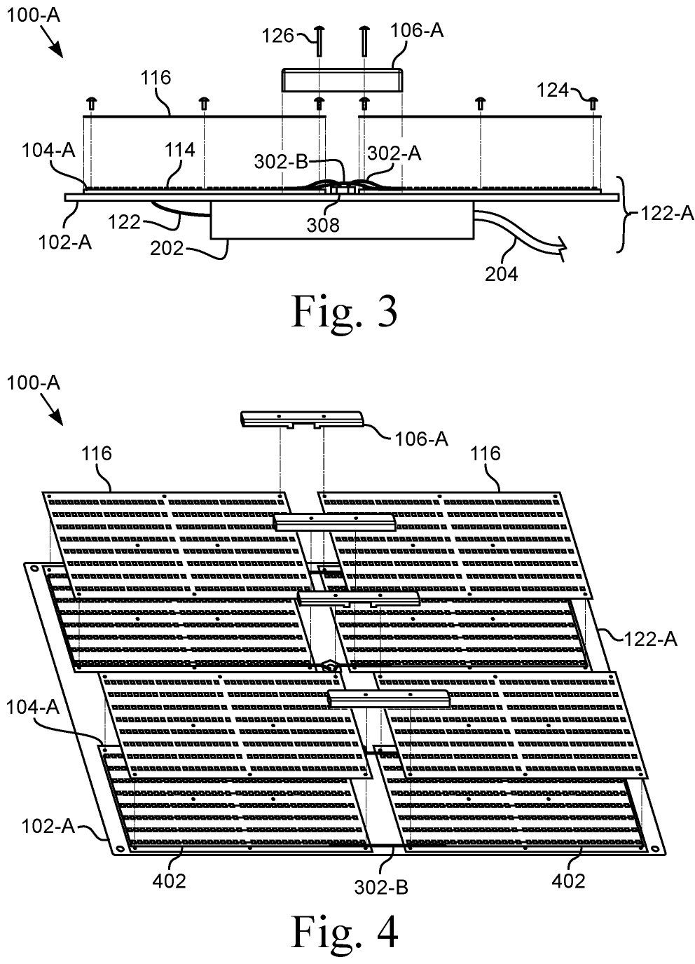

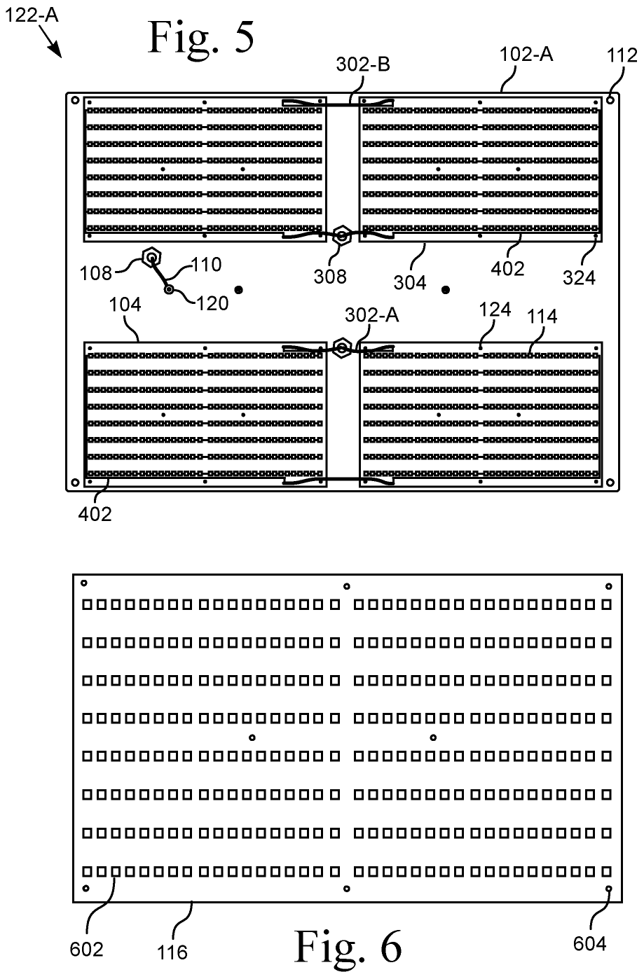

FIG. 3 illustrates an exploded upside-down side view of one embodiment of the grow light 100-A. FIG. 4 illustrates a partial exploded view of the grow light 100-A. FIG. 5 illustrates a bottom view of the lamp portion 122-A of the base plate 102-A of the grow light 100-A without the shields 106, 116. FIG. 6 illustrates a plan view of a circuit shield 116.

The light assemblies 104-A are shown proximate the bottom side 212 of the base plate 102-A. The circuit shields 116 are shown above the light assemblies 104-A with the fasteners 124 poised to secure the circuit shields 116 to the light assemblies 104-A and the base plate 102-A. In the illustrated embodiment, the fasteners 124 secure both the circuit shields 116 and the light assemblies 104-A to the base plate 102-A. In another embodiment, the circuit shields 116 are attached to the light assemblies 104-A with fasteners separate from the fasteners securing the light assemblies 104-A to the base plate 102-A.

The wire covers 106-A are shown with the circuit shields 116 between the wire covers 106 and the light assemblies 104-A. The fasteners 126 for the wire shields 106-A have a length sufficient to extend through the wire covers 106-A, the circuit shield 116, the light assemblies 104-A, and into the base plate 102. Power supply conductors 302-A extend from the power supply pass-through fittings 308 to the light assemblies 104-A. Interconnect conductors 302-B extend between adjacent pairs of light assemblies 104-A in order to electrically connect the adjacent light assemblies 104-A. The wire covers 106-A, when attached to the lamp portion 122-A, cover the conductors 302-A, 302-B. The conductors 302-A, 302-B, the circuit traces 402 on the light assemblies 104-A, and the LEDs 114 form an electrical circuit powered by the power supply 202.

FIG. 5 illustrates an embodiment of the light assemblies 104-A with circuit traces 402 that connect the LEDs 114. The circuit traces 402 provide the electrical connections necessary to connect the LEDs 114 to the power supply conductors 302-A from the output of the power supply 202. A person of ordinary skill in the art will recognize that the topology of the circuit traces 402 will vary depending upon the voltage and power requirements of the LEDs 114.

The circuit traces 402, in one embodiment, are electrical conductors covered with an insulated coating. The circuit traces 402 on each light assembly 104-A are also covered with the circuit shield 116. Two light assemblies 104-A are electrically connected in series with conductor 302-B. The pair of series connected light assemblies 104-A are powered by two conductors 302-A from the power supply 202. In other embodiments, the light assemblies 104-A are connected with other topologies in order to provide power to illuminate the associated LEDs 114. The wire covers 106-A enclose the conductors 302 that would otherwise be exposed, providing an electrical, insulated cover.

In one embodiment, the light assemblies 104-A are integral with the base plate 102-A. That is, the base plate 102-A has a surface 212 that includes circuit traces 402 and surface mount LEDs 114. In one such embodiment, the LEDs 114 are arranged in multiple arrays that correspond to multiple light assemblies 104-A. In another embodiment, the LEDs 114 are arranged in a single array that corresponds to a single light assembly 104-A that extends over most of the surface area of the base plate 102-A.

FIG. 6 illustrates an embodiment of the circuit shield 116. The circuit shield 116 is a planar sheet of flame retardant material with a dielectric strength sufficient for the voltages applied by the power supply 202 and/or seen by the circuit on the light assembly 104. The circuit shield 116 includes holes 602 that are sized and spaced so as to receive the LEDs 114 on the light assembly 104. That is, location of the holes 602 correspond to the location of the LEDs 114. In one such embodiment, the holes 602 are punched in the shield 116. Each hole 602 is sized to fit closely around the protruding portion of the LED in order to minimize the space between the circuit shield 116 and each LED 114. In this way the fire protection function of the circuit shield 116 is maximized.

In one embodiment, the circuit shield 116 is attached to the light assembly 104 with fasteners 124, such as rivets or screws. In another embodiment, the circuit shield 116 is attached to the light assembly 104 with an adhesive. In one such embodiment, the adhesive is a pressure sensitive, adhesive backing fixed to a surface of the circuit shield 116. The adhesive backing is covered with a release liner or removable sheet that allows for the circuit shield 116 to be pressed against the surface of the LED circuit on the light assembly 104. The adhesive backing has high temperature resistance so that the circuit shield 116 remains in position under all expected conditions.

In one embodiment, the circuit shield 116 is formed from a product such as 3M Flame Barrier FRB series sheet. The sheet of material is die cut to have the openings 602 positioned to receive the LEDs 114. For the embodiment that uses fasteners 124, 126, the fastener openings 604 are also die cut. In an embodiment in which fasteners 124 are not used, the circuit shield 116 has an adhesive backing.

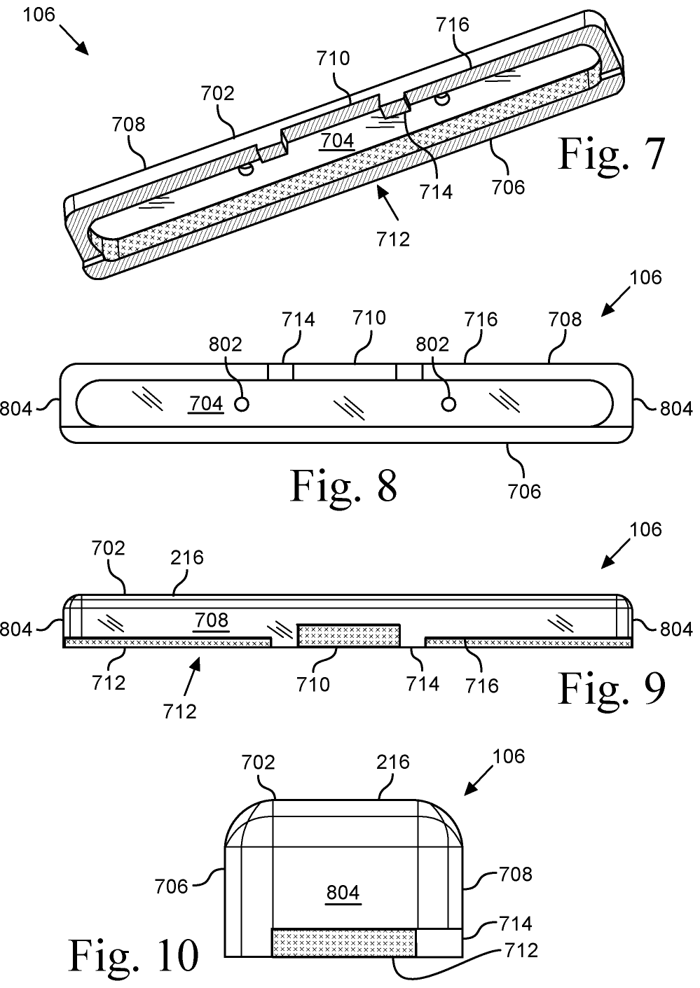

FIG. 7 illustrates a perspective view showing the open side 712 of one embodiment of a wire shield 106. FIG. 8 illustrates a plan view of the open side of the wire shield 106 shown in FIG. 7. FIG. 9 illustrates a side view of the wire shield 106 shown in FIG. 7. FIG. 10 illustrates an end view of the wire shield 106 shown in FIG. 7. The bottom 216 of the cover 106 is referenced relative to the position of the cover 106 when installed on the lamp portion 122 of the grow light 100. That is, the bottom 216 of the cover 106 is the side that faces in the same direction as the bottom surface 212 of the base plate 102. In other words, bottom 216 of the cover 106 is the side that is closest to the plants to be illuminated by the light 100. When attached to the lamp portion 122, the open side, or opening, 712 of the wire cover 106 is adjacent the lamp portion 122 and the bottom side 216 of the wire cover 106 is the side distal to the lamp portion 122.

The wire cover 106 is a box 702 that is substantially rectangular and has five sides 216, 706, 708, 804 with an open side 712. The wire cover 106 has a bottom side or surface 216 opposite the one open side, or opening, 712. The bottom surface 216 includes a pair of openings 802 that receive the fasteners 126 that secure the wire shield 106 to the plate 102. The open side 712 is configured to be placed against the bottom side 212 and the fire protection shield 116. The inside of the wire cover 106 is a cavity 704 defined by the bottom 216, the outer side 706, the inner side 708, and the ends 804. The cavity 704 is sized to receive and enclose the conductors 302-A, 302-B that protrude above the surface of the lamp assemblies 104 and circuit shields 116. The wire cover 106 contains and protects the conductors 302-A, 302-B.

The outer side 706 of the wire cover 106 extends between the two ends 804. The outer side 706 is relative to the light assembly 104, that is, the outer side 706 is the side that is outermost or furthest away from the light assembly 104. The outer side 706 is the side of the cover 106 that is closest to or proximate the edge of the base plate 102. The outer side 706 is configured to engage the bottom surface 212 of the base plate 102 with a portion of the light assembly 104 extending under the wire cover 106 proximate the open side 712.

The inner side 708 of the wire cover 106 extends between the two ends 804 opposite the outer side 706. The inner side 708 is relative to the light assembly 104, that is, the inner side 708 is the side that is closest or proximate to the light assembly 104. The inner side 708 is the side that is furthest away from or distal to the edge of the base plate 102. The inner side 708 includes a pair of nubs 714 with a recess 710 therebetween and a cutout 716 outboard of the nubs 714.

The inner side 708 is configured to engage the light shields 116 on adjacent light assemblies 104 and the bottom surface 212 of the base plate 102 between the adjacent light assemblies 104. The inner side 708 has a recess 710 sized and configured to receive a portion of the pass-through fittings 308 that carry the conductors 302-A between the power supply 202 and the light assemblies 104. The outboard cutouts 716 on the inner side 708 have a surface configured to engage the circuit shields 116 that butt against the protruding nubs 714. Each nub 714 fills the gap between a light assembly 104 and the pass-through fitting 308. The nubs 714 protrude and extend to the bottom 212 of the plate 102. In this way, the opening 712 at the top of the wire cover 106 is proximate the base plate 102, the light assemblies 104, and the fitting 308, thereby ensuring that the conductor 302-A is enclosed.

The conductor 302-B that electrically connects two adjacent light assemblies 104 does not have an associated pass-through connector 308. When the wire cover 106 is positioned over the conductor 302-B the recess 710 on the inner side 708 of the cover 106 is open. In another embodiment of the wire cover 106, the inner side 708 does not include a recess 710 between a pair of nubs 714. Instead, the top surface 712 of the inner side 708 engages the bottom surface 212 of the base plate 102 between the adjacent light assemblies 104. In such an embodiment, a single nub 714 extends between the adjacent light assemblies 104, filling the space between the two assemblies 104.

The wire cover 106 provides electrical protection for the conductors 302 under the cover 106. In one embodiment, the wire cover 106 is sized to provide an air space in the cavity 704 with the air space being a gap between the conductors 302 and the inside surface of the wire cover 106. In one embodiment, the wire cover 106 is an electrical insulator, that is, the wire cover 106 is made of or is coated with a non-electrically conducting material.

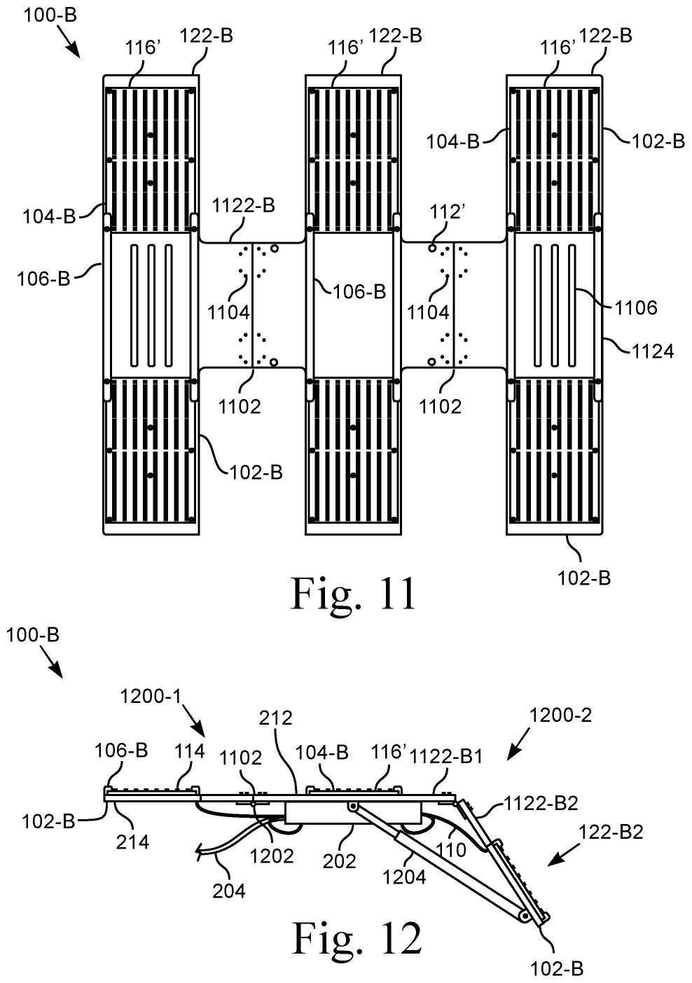

FIG. 11 illustrates a bottom view of a second embodiment of a grow light 100-B with shields 106-B, 116′ in place. FIG. 12 illustrates an upside-down side view of the grow light 100-B of FIG. 11. The illustrated embodiment of the grow light 100-B includes three opposing pairs of lamp portions 122-B, each one with a circuit shield 116′ and a pair of conductor shields, or wire covers, 106-B between each opposing pair of lamp portions 122-B.

The grow light 100-B includes a base plate 102-B, multiple light assemblies 104-B on the bottom side 212, a power supply 202 on the top side 214, and hinges 1202 joining the bridge sections 1122 between adjacent pairs of lamp portions 122-B. In one embodiment, the base plate 102-B is an aluminum plate that serves as a heat sink for dissipating heat generated by the lamp portions 122-B. In one such embodiment, the plate 102-B is surface treated to have high thermal emissivity, which aids in dissipating heat generated by the light assemblies 104-B. For example, the plate 102-B is powder coated or anodized. The base plate 102-B includes spaced, elongated openings 1106 that allow air flow between the top and bottom surfaces 212, 214.

The base plate 102-B has a double-H configuration divided into sections that include three pairs of opposing lamp portions 122-B. Each lamp portion 122-B is the part or portion of the base plate 102-B that supports a light assembly 104-B and provides a heat sink for the heat generated by that light assembly 104-B. Each pair of opposing lamp portions 122-B is separated by a base portion 1124. The adjacent base portions 1124 are joined with a bridge member 1122-B. The bridge members, or bar sections, 1122-B form the bar of the H-shape and adjacent pairs of opposing lamp portions 122-B and the associated base portions 1124 form the two stems of the H-shape. The center opposing lamp portions 122-B form the shared stem for the double H-shape of the illustrated embodiment of the base plate 102-B.

The illustrated embodiment shows three parallel, elongated openings 1106 in the two outermost base portions 1124. The openings 1106 are slots that allow air to flow through the base plate 102-B, thereby aiding the cooling of the grow light 100-B. The central base portion 1124 does not have slots 1106 because the power supply 202 is mounted on the top side 214 of the base plate 102-B.

The bridge members 1122-B have a split 1102 that separates each bridge member 1122-B into two bridge member halves 1122-B1, 1122-B2 that are connected with a pair of hinges 1202. The hinges 1202 are secured to the top surface 214 of the base plate 102-B with multiple fasteners 1104. The outermost bridge member half 1122-B2 and the outermost pair of lamp portions 122-B2 pivot around the hinges 1202. In this way, the light assemblies 104-B on the pair of opposing lamp portions 122-B2 are movable between a first position 1200-1 and a selected second position 1200-2 relative to the central portion of the base plate 102-B.

The first position 1200-1 has the base plate 102-B planar with the two half members 1122-B1, 1122-B2 butted together such that the base plate 102-B is flat. The second position 1200-2 is where the base plate 102-B is not planar, that is, the two half members 1122-B1, 1122-B2 are rotated about the hinges 1202. In the second position 1200-2, the light from one pair of opposing lamp portions 122-B2 is directed at an angle relative to the central pair of lamp assemblies 122-B. In one embodiment, the angle formed by the pair of opposing lamp portions 122-B2 relative to the central pair of lamp assemblies 122-B is selectable to accommodate the configuration and arrangement of the plants to be illuminated. For example, the pair of opposing lamp portions 122-B2 is positioned at a right angle to the central pair of lamp assemblies 122-B to illuminate a section of vertical plant growth. The folding base plate 102-B also provides for a compact arrangement, such as for shipping, with the outermost bridge member half 1122-B2 and the outermost pair of lamp portions 122-B2 rotated relative to the central pair of lamp assemblies 122-B.

In various embodiments, the outermost bridge member half 1122-B2 and the outermost pair of lamp portions 122-B2 are secured in position by a locking pin engaging the hinge 1202 or by a support member 1204, such as illustrated. The support member 1204, such as illustrated, is a telescoping beam that locks the outermost pair of lamp portions 122-B2 in a selected position. In another embodiment, the support member 1204 is a cable or chain in tension that holds the outermost pair of lamp portions 122-B2 in position. In another embodiment, the base plate 102-B is a single plate that does not include the hinges 1202 or the split 1102 in the bridge members 1122-B.

The base plate 102-B includes holes 112′ for suspending or supporting the grow light 100-B. The holes 112′ are positioned on opposite sides of the central lamp portions 122-B. In various embodiments, the holes 112′ receive eye-bolts or hooks that are attached to chains, straps, or cables suspended from an overhead structure, such as a ceiling. In this way the grow light 100-B is supported above the plants to be illuminated with the bottom 212 of the grow light 100-B facing the plants to be illuminated.

The bottom side 212 of the base plate 102-B includes three pairs of opposing light assemblies 104-B, with each light assembly 104-B having multiple rows of light emitting diodes (LEDs) 114. The light assemblies 104-B are similar to those as described above with respect to the first embodiment of the grow light 100-A.

Each of the light assemblies 104-B has a corresponding circuit shield 116′. The circuit shields 116′ have holes or openings 602 sized and spaced to receive the LEDs 114 on the light assemblies 104-B. The circuit shields 116′ are similar to those 116 described above with respect to the first embodiment of the grow light 100-A. The circuit shields 116′ primarily differ in the location of the various holes or openings 602, 604 as those holes 602, 604 are positioned to match the positions of the LEDs 114 and any mounting fasteners.

Each of the pair of opposing light assemblies 104-B have wire covers 106-B extending therebetween. The illustrated wire covers 106-B are longer than the covers 106-A shown in FIG. 1 because the light assemblies 104-B are further apart. Other than the length and the open end 712 conforming to the configuration on the bottom surface 212 of the base plate 102, the wire covers 106-B are similar to those 106-A described above with respect to the first embodiment of the grow light 100-A. The bottom surface 216 of the wire covers 106-B extends beyond the LEDs 114 protruding from the light assemblies 104-B and past the circuit shields 116′. In this way, the wire covers 106-B support the grow light 100 and protect the light assemblies 104-B when the grow light 100-B is positioned on a flat surface, such as during installation or maintenance. The nubs 714 and the recess 710, if one, extend to fill the gap between the light assemblies 104-B.

The top side 214 of the base plate 102-B includes a power supply 202 that is attached to the plate 102-B. Extending from the power supply 202 is a power cable 204. The power cable 204 is configured to connect to a power source for providing power to the grow light 100-A.

The shields 106, 116 include various functions. The function of providing an electrical enclosure for conductors 302-A, 302-B connected to the light assemblies 104 is implemented, in one embodiment, by a wire cover 106.

The function of providing a stand-off support for the light assemblies 104 on the lamp portion 122 is implemented, in one embodiment, by the wire covers 106 being sized such that the bottom 216 of each cover 106 extends beyond the light assemblies 104 with the protruding LEDs 114. In this way the grow light 100 is configured to have its bottom side placed on a planar surface with the light assemblies 104 protected from contacting the planar surface.

The function of minimizing the size of the grow light 100 is implemented, in one embodiment, by the wire covers 106 being dimensioned to have a cavity 704 that encloses the conductors 302 with only enough space between the cover 106 and the conductors 302 to provide an insulating gap.

The function of providing a fire barrier for the light assemblies 104 is implemented, in one embodiment, by the circuit shields 116 that are positioned on the bottom surface of the light assemblies 104.

The function of maximizing light transmission of the light assemblies 104 through a circuit shield 116 is implemented, in one embodiment, by the circuit shields 116 covering the light assemblies 104 while having openings 602 through which a portion of the LEDs 114 pass through the circuit shields 116 without impeding the light emission of the LEDs 114.

The function of maximizing light transmission of the light assemblies 104 is implemented, in one embodiment, by the circuit shields 116 having a reflective outer surface. In one such embodiment, the outer surface of the circuit shields 116 is white.

The function of dissipating heat generated by the grow light 100 is implemented, in one embodiment, by the base plate 102 being surface treated to have high thermal emissivity. In various such embodiments, the base plate 102 is powder coated or anodized such that heat is readily radiated from exposed portions of the base plate 102.

The function of dissipating heat generated by the grow light 100 is implemented, in one embodiment, by slots 1106 in the base plate 102-B. The slots 1106 allow for air flow between the bottom side 212 and the top side 214 of the base plate 102-B.

A fire barrier is defined as a structure that is resistant to fire and prevents or inhibits the movement of a fire from one side of the fire barrier to the other. The wire cover 106 is a fire barrier because it prevents or inhibits the movement of a fire from inside the cavity 704 to outside the cover 106. The wire cover 106 has the functions of preventing, inhibiting, and containing any fire caused by the conductors 302 enclosed in the cavity 704 of the wire cover 106.

The circuit shield 116 is a fire barrier because it prevents or inhibits the movement of a fire from the electrical circuit traces 402 on the light assembly 104 from the opposite, exposed side of the circuit shield 116. The circuit shield 116 has the functions of preventing, inhibiting, and containing any fire caused by the electrical connections to the LEDs 114 on the light assembly 104. Those electrical connections to the LEDs 114 include the conductors forming the circuit traces 402 on the surface of the light assembly 104. The wire covers 106 and circuit shields 116 are fire barriers that protect against a fault of the conductors 302 and/or the circuit traces 402 or LEDs 114 on the light assembly 104, respectively.

An electrical barrier is defined as a structure that is an electrical insulator, that is, it is not electrically conductive and has sufficient dielectric strength to prevent and/or inhibit the voltage on one side of the electrical barrier from passing to the other side. The wire cover 106 is an electrical barrier because it is not electrically conductive and has sufficient dielectric strength to prevent and/or inhibit the voltage from the conductors 302 inside the cavity 704 from passing to outside the cover 106. The wire cover 106 has the function to electrically insulate the conductors 302 inside the cavity 704 of the wire cover 106.

The circuit shield 116 is an electrical barrier because it is not electrically conductive and has sufficient dielectric strength to prevent and/or inhibit the voltage from the electrical circuit on the light assembly 104 from passing to the opposite, exposed side of the circuit shield 116. The circuit shield 116 has the function of electrically insulating the electrical connections to the LEDs 114. Those electrical connections to the LEDs 114 include the conductors forming the circuit traces 402 on the surface of the light assembly 104. The wire covers 106 and circuit shields 116 are electrical barriers that protect against a fault of the conductors 302 and/or the circuit traces 402 or LEDs 114 on the light assembly 104, respectively.

From the foregoing description, it will be recognized by those skilled in the art that protective shields 106, 116 for both fire protection and electrical protection of a grow light 100 have been provided. The fire protection shields 116, 116′ are positioned over the light assemblies 104 and the shields 116, 116′ have openings 602 through which a portion of each LED 114 is exposed. The electrical protection shields 106-A, 106-B are wire covers or enclosures that are positioned over the conductors 302 that are electrically connected to the light assemblies 104-A, 104-B.

In one embodiment, the base plate 102-A is a rectangular structure that supports multiple light assemblies 104-A. In another embodiment, the base plate 102-B has a double-H shape with multiple pairs of light assemblies 104-B. In one such embodiment, the base plate 102-B is a solid structure that is planar. In another such embodiment, the base plate 102-B has splits 1102 in the bridge sections 1122-B that allow the outermost pairs 122-B2 of the lamp portions 122-B to pivot upward.

While the present invention has been illustrated by several embodiments and while the illustrative embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus, and illustrative examples shown and described. Accordingly, departures may be made from such details without departing from the spirit or scope of applicants' general inventive concept.

What is claimed is:

1. An apparatus for a light, said apparatus comprising:
a light assembly including a plurality of light emitting diodes on one surface of said light assembly, said light assembly including a first conductor electrically connected to said plurality of light emitting diodes, said light assembly including a second conductor electrically connected to said first conductor, said second conductor providing a power connection to said plurality of light emitting diodes;
a circuit shield configured to attach to said one surface of said light assembly, said circuit shield dimensioned to cover said first conductor, and said circuit shield being a fire barrier protecting against a fault with said first conductor; and
a wire shield configured to attach to said one surface of said light assembly, said wire shield enclosing said second conductor, and said wire shield is an electrical and fire barrier protecting against a fault with said second conductor.

2. The apparatus of claim 1 wherein said circuit shield is a planar sheet, and said circuit shield includes a plurality of openings spaced to correspond to said plurality of light emitting diodes whereas said light emitting diodes project light through said plurality of openings when said plurality of light emitting diodes are energized.

3. The apparatus of claim 2 wherein said circuit shield is an electrical insulator.

4. The apparatus of claim 2 wherein said circuit shield is attached to said light assembly with an adhesive.

5. The apparatus of claim 2 wherein said circuit shield is attached to said light assembly with a plurality of fasteners.

6. The apparatus of claim 1 wherein said wire shield has a box-shape with an opening defined by a bottom and four sides, said bottom and said four sides define a cavity dimensioned to receive a portion of said second conductor, and said cavity dimensioned and configured to receive said second conductor through said opening.

7. The apparatus of claim 1 further including a base plate having a first surface and a second surface; said first surface of said base plate supporting said light assembly, said second surface of said base plate supporting a power supply providing power to said plurality of light emitting diodes, and said second conductor in electrical connection to said power supply.

8. The apparatus of claim 7 wherein said base plate includes at least one hinge on said second surface wherein a first portion of said base plate pivots relative to a second portion of said base plate, wherein said base plate has a first configuration with said first and second portions being planar and a second configuration with said first portion being non-planar with said second portion.

9. The apparatus of claim 8 wherein said base plate has a double H-shape, said at least one hinge on a bar section of said double H-shape.

10. An apparatus for a light, said apparatus comprising
a light assembly including a plurality of light emitting diodes on a surface of said light assembly, said light assembly including a first conductor connected to said plurality of light emitting diodes, said first conductor including a circuit trace on said surface of said light assembly, said light assembly including a second conductor electrically connected to said first conductor and a power supply, said second conductor providing a power connection to said plurality of light emitting diodes; and
a circuit shield configured to attach to said surface of said light assembly, said circuit shield dimensioned to cover said first conductor, and said circuit shield being a fire barrier protecting against a fault with said first conductor.

11. The apparatus of claim 10 wherein said circuit shield is a planar sheet, and said circuit shield includes a plurality of openings spaced to correspond to said plurality of light emitting diodes whereas said light emitting diodes project light through said plurality of openings when said plurality of light emitting diodes are energized.

12. The apparatus of claim 10 wherein said circuit shield is an electrical insulator.

13. The apparatus of claim 10 wherein said circuit shield is attached to said light assembly with an adhesive.

14. The apparatus of claim 10 wherein said circuit shield is attached to said light assembly with a plurality of fasteners.

15. The apparatus of claim 10 further including a wire shield configured to enclose a portion of said second conductor that is disposed proximate said first surface of said base plate.

16. An apparatus for a light, said apparatus comprising
a base plate having a first surface and a second surface;
a power supply attached to said second surface of said base plate;
a light assembly on said first surface of said base plate, said light assembly including a plurality of light emitting diodes on said light assembly, said light assembly including a first conductor electrically connected to said plurality of light emitting diodes, said light assembly including a second conductor electrically connected to said first conductor, said second conductor electrically connected to said power supply, said second conductor providing a power connection to said first conductor; and
a wire shield configured to enclose a portion of said second conductor that is disposed proximate said first surface of said base plate.

17. The apparatus of claim 16 wherein said wire shield includes a bottom and four sides forming a box-shape with an opening, said bottom and said four sides define a cavity dimensioned to receive a portion of said second conductor, and said cavity dimensioned and configured to receive said second conductor through said opening.

18. The apparatus of claim 16 wherein said wire shield is an electrical insulator protecting against a fault with said second conductor.

19. The apparatus of claim 16 wherein said wire shield is a fire barrier protecting against a fault with said second conductor.

20. The apparatus of claim 16 further including a circuit shield configured to attach to said surface of said light assembly, said circuit shield dimensioned to cover said first conductor, and said circuit shield being a fire barrier protecting against a fault with said first conductor, said circuit shield is a planar sheet, and said circuit shield includes a plurality of openings spaced to correspond to said plurality of light emitting diodes whereas said light emitting diodes project light through said plurality of openings when said plurality of light emitting diodes are energized
